(19) United States
(12) Patent Application Publication
(10) Pub. No.: US 2014/0300591 A1
(43) Pub. Date: Oct. 9, 2014

(54) DATA DRIVER AND DISPLAY APPARATUS

(71) Applicant: Sony Corporation, Tokyo (JP)

(72) Inventors: Takeshi Aoki, Kanagawa (JP); Iwao Ushinohama, Kanagawa (JP)

(73) Assignee: SONY CORPORATION, Tokyo (JP)

(21) Appl. No.: 14/192,942

(22) Filed: Feb. 28, 2014

(30) Foreign Application Priority Data
Apr. 3, 2013 (JP) 2013-077483
Jan. 20, 2014 (JP) 2014-007437

(51) Int. Cl. G09G 3/36

(52) U.S. Cl. CPC G09G 3/3696
USPC 345/212

(57) ABSTRACT

A data driver for driving data lines of a display panel includes a reference voltage section, a resistance circuit, and a selector section. The reference voltage section has at least three kinds of reference voltage sources for supplying their respective reference voltages, arranged in descending or ascending order of voltage values. The resistance circuit has a plurality of voltage division nodes connected between adjacent reference voltage sources, for dividing the reference voltages. The selector section selects and allows output of one voltage corresponding to an input value of a gradation signal, among the reference voltages or the voltages of the voltage division nodes. When the voltage to be output corresponding to the value of the gradation signal is one of the voltages of the voltage division nodes, the selector section selects at least one reference voltage and subsequently selects the voltage of the corresponding voltage division node.

### CROSS REFERENCE TO RELATED APPLICATIONS

This application claims the benefit of Japanese Priority Patent Application JP 2013-077483 filed Apr. 3, 2013, and Japanese Priority Patent Application JP 2014-007437 filed Jan. 20, 2014, the entire contents of each of which are incorporated herein by reference.

### BACKGROUND

The present disclosure relates to a data driver; and a display apparatus having such a data driver.

In display apparatuses having a display panel such as electroluminescent display panels and liquid crystal display panels, data drivers which generate a voltage corresponding to gradation of an image may be used in order to display images. For example, as disclosed in Japanese Patent Application Laid-Open No. 2003-233355 and the like, a data driver configured to appropriately select and output a voltage corresponding to a value of a gradation signal, which voltage is selected from a plurality of reference voltages and divided voltages which are obtained by dividing the reference voltages by a resistance circuit including a ladder resistor (gamma resistor) and the like, has been known.

### SUMMARY

With the increase of the image resolution and the frame rate in display apparatuses, there is a demand for the data drivers to operate at higher speed. However, in the data driver which is configured to divide the reference voltages by the resistance circuit and the like, a delay in a voltage waveform which is due to the ladder resistance, parasitic capacitance or the like becomes a problem upon high speed operation. Although it is possible to reduce the delay in the waveform if a resistance value of the resistor that makes up the resistance circuit is reduced, this would lead to an increase in the current flowing through the resistance circuit, thereby leading to an increase in power consumption of the data driver.

In view of the above-mentioned circumstances, it is desirable to provide a high-speed data driver which can realize high speed without reducing a ladder resistance value; and to provide a display apparatus having such a data driver.

According to a first embodiment of the present disclosure, there is provided a data driver for driving data lines of a display panel, which data driver includes a reference voltage section, at least one resistance circuit, and a selector section.

The reference voltage section has at least three kinds of reference voltage sources configured to supply their respective reference voltages, the reference voltage sources being arranged in descending or ascending order of voltage values.

Each resistance circuit has a plurality of voltage division nodes connected between adjacent reference voltage sources, the voltage division nodes dividing the reference voltages.

The selector section is configured to select and allow output of one voltage among the reference voltages or the voltages of the voltage division nodes, the voltage corresponding to an input value of a gradation signal. The selector section is configured to, when the voltage to be output corresponding to the value of the gradation signal is one of the voltages of the voltage division nodes, select one of two reference voltages from two reference voltage sources being connected to the resistance circuit including a corresponding voltage division node and subsequently select the voltage of the corresponding voltage division node.

According to the first embodiment of the present disclosure, there is also provided a display apparatus including a display panel and a data driver for driving data lines of the display panel.

The data driver includes a reference voltage section, at least one resistance circuit, and a selector section.

The reference voltage section has at least three kinds of reference voltage sources configured to supply their respective reference voltages, the reference voltage sources being arranged in descending or ascending order of voltage values.

Each resistance circuit has a plurality of voltage division nodes connected between adjacent reference voltage sources, the voltage division nodes dividing the reference voltages.

The selector section is configured to select and allow output of one voltage among the reference voltages or the voltages of the voltage division nodes, the voltage corresponding to an input value of a gradation signal. The selector section is configured to, when the voltage to be output corresponding to the value of the gradation signal is one of the voltages of the voltage division nodes, select one of two reference voltages from two reference voltage sources being connected to the resistance circuit including a corresponding voltage division node and subsequently select the voltage of the corresponding voltage division node.

According to a second embodiment of the present disclosure, there is provided a data driver for driving data lines of a display panel, which data driver includes a reference voltage section, at least one resistance circuit, and a selector section.

The reference voltage section has at least three kinds of reference voltage sources configured to supply their respective reference voltages, the reference voltage sources being arranged in descending or ascending order of voltage values.

Each resistance circuit has a plurality of voltage division nodes connected between adjacent reference voltage sources, the voltage division nodes dividing the reference voltages.

The selector section is configured to select and allow output of one voltage among the reference voltages or the voltages of the voltage division nodes, the voltage corresponding to an input value of a gradation signal. The selector section is configured to, when the voltage to be output corresponding to the value of the gradation signal is one of the voltages of the voltage division nodes, select at least one reference voltage and subsequently select the voltage of the corresponding voltage division node.

According to the second embodiment of the present disclosure, there is also provided a display apparatus including a display panel and a data driver for driving data lines of the display panel.

The data driver includes a reference voltage section, at least one resistance circuit, and a selector section.

The reference voltage section has at least three kinds of reference voltage sources configured to supply their respective reference voltages, the reference voltage sources being arranged in descending or ascending order of voltage values.

Each resistance circuit has a plurality of voltage division nodes connected between adjacent reference voltage sources, the voltage division nodes dividing the reference voltages.

The selector section is configured to select and allow output of one voltage among the reference voltages or the voltages of the voltage division nodes, the voltage corresponding to an input value of a gradation signal. The selector section is configured to, when the voltage to be output corresponding to the value of the gradation signal is one of the voltages of the voltage division nodes, select at least one reference voltage and subsequently select the voltage of the corresponding voltage division node.

In the data drivers of the first and second embodiments of the present disclosure, in cases where the voltage to be output corresponding to the value of the gradation signal is a voltage of the voltage division node, the selector section selects a reference voltage and subsequently selects the voltage of the corresponding voltage division node. This may shorten the time required for the rise and fall of the voltage output from the data driver. Thus, it is possible to realize high-speed data drivers. It should be noted that the effects described herein are non-limitative examples. Some embodiments of the present disclosure may also have additional effects.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a display apparatus according to a first embodiment;

FIG. 2 is a schematic circuit diagram for explaining a configuration of a data driver of a part which contributes to driving the n-th data line;

FIG. 3A is a schematic circuit diagram for explaining an operation in a case where a reference voltage is selected and output;

FIG. 3B is a schematic circuit diagram for explaining an operation in a case where a voltage of a voltage division node is selected and output;

FIG. 4 is a schematic graph for explaining a change in voltage at an input part of an output amplifier in the case where the reference voltage is selected and output; and a change in voltage at the input part of the output amplifier in the case where the voltage of the voltage division node is selected and output;

FIG. 5 is a schematic graph for explaining a change in voltage at the input part of the output amplifier in the case where a selector section selects the reference voltage which shows an overshoot with respect to the voltage to be output, from two reference voltages, and subsequently selects the voltage of the corresponding voltage division node;

FIG. 6 is a schematic graph for explaining a change in voltage at the input part of the output amplifier in the case where the selector section selects the reference voltage which shows an undershoot with respect to the voltage to be output, from two reference voltages, and subsequently selects the voltage of the corresponding voltage division node;

FIG. 7 is a schematic diagram for explaining a configuration of a control circuit of the selector section in the first embodiment;

FIG. 8 is a table for explaining the configuration and the like, of the table in the first embodiment;

FIG. 9 is a schematic diagram for explaining a configuration of a control circuit of a selector section in a variation example of the first embodiment;

FIG. 10 is a table for explaining the configuration and the like, of the table in the variation example of the first embodiment;

FIG. 11 is a schematic circuit diagram, showing a display apparatus according to a second embodiment, for explaining a configuration of a data driver of a part which contributes to driving the n-th data line;

FIG. 12 is a schematic diagram for explaining a normal writing operation;

FIG. 13 is a schematic diagram showing a first example of selecting a plurality of reference voltages;

FIG. 14 is a schematic diagram showing a second example of selecting a plurality of reference voltages;

FIG. 15 is a schematic diagram showing a third example of selecting a plurality of reference voltages;

FIG. 16A is a figure schematically showing a circuit configuration of selecting three reference voltages;

FIG. 16B is a figure showing a circuit which is substantially equivalent to the circuit configuration shown in FIG. 16A;

FIG. 17 is a schematic graph for explaining a change in voltage at the input part of the output amplifier; and

FIG. 18 is a table for explaining the configuration and the like, of the table in a variation example of the second embodiment.

### DETAILED DESCRIPTION OF EMBODIMENTS

Hereinafter, some embodiments of the present disclosure will be described with reference to the drawings. The present disclosure is not limited to the embodiments. A variety of numerical values and materials in the embodiments are merely exemplification. In the following description, structural elements that have substantially the same function and structure are denoted with the same reference symbols, and repeated explanation of these structural elements will be omitted. The explanation will be given in the following order.

1. Overview of data driver according to the present disclosure and display apparatus having such data driver

2. First embodiment

3. Second embodiment and others

### OVERVIEW OF DATA DRIVER ACCORDING TO THE PRESENT DISCLOSURE AND DISPLAY APPARATUS HAVING SUCH DATA DRIVER

A data driver according to a first embodiment of the present disclosure and a data driver used in a display apparatus according to the first embodiment of the present disclosure (hereinafter, both may be simply referred to as “data driver of the first embodiment of the present disclosure”) may be configured such that when the voltage to be output corresponding to the value of the gradation signal is the voltage of the voltage division node, the selector section selects one reference voltage which shows an overshoot with respect to the voltage to be output, from two reference voltages, and subsequently selects the voltage of the corresponding voltage division node.

Alternatively, the data driver of the first embodiment of the present disclosure may be configured such that when the voltage to be output corresponding to the value of the gradation signal is the voltage of the voltage division node, the selector section selects one reference voltage which shows an undershoot with respect to the voltage to be output, from two reference voltages, and subsequently selects the voltage of the corresponding voltage division node.

A data driver according to a second embodiment of the present disclosure and a data driver used in a display apparatus according to the second embodiment of the present disclosure (hereinafter, both may be simply referred to as “data driver of the second embodiment of the present disclosure”) may be configured such that when the voltage to be output corresponding to the value of the gradation signal is the voltage of the voltage division node, the selector section selects at least one reference voltage which shows an overshoot with respect to the voltage to be output, and subsequently selects the voltage of the corresponding voltage division node.

Otherwise, the data driver of the second embodiment of the present disclosure may be configured such that when the voltage to be output corresponding to the value of the gradation signal is the voltage of the voltage division node, the selector section selects at least one reference voltage which shows an undershoot with respect to the voltage to be output, and subsequently selects the voltage of the corresponding voltage division node.

In addition, the data driver of the second embodiment of the present disclosure may be configured such that when the voltage to be output corresponding to the value of the gradation signal is the voltage of the voltage division node, the selector section selects at least one reference voltage which shows an overshoot with respect to the voltage to be output and at least one reference voltage which shows an undershoot with respect to the voltage to be output, and subsequently selects the voltage of the corresponding voltage division node.

The data drivers of the first and second embodiments of the present disclosure (hereinafter, these may be simply referred to as “data driver of the present disclosure”) including the above-mentioned desirable configurations may further include a table containing data of a length of a period to select the reference voltage, and a length of a period to select the voltage of the corresponding voltage division node, which data corresponds to the input value of the gradation signal.

The data driver may be configured such that the selector section selects the reference voltage or the voltage of the voltage division node in a period controlled based on the data contained in the table.

The data driver of the present disclosure including the above-mentioned desirable configurations may be configured such that when the voltage to be output corresponding to the value of the gradation signal is the voltage of the voltage division node, the selector section selects the reference voltage in a pre-charging period in a horizontal scanning period, and subsequently selects the voltage of the corresponding voltage division node in a data writing period longer than the pre-charging period in the same horizontal scanning period.

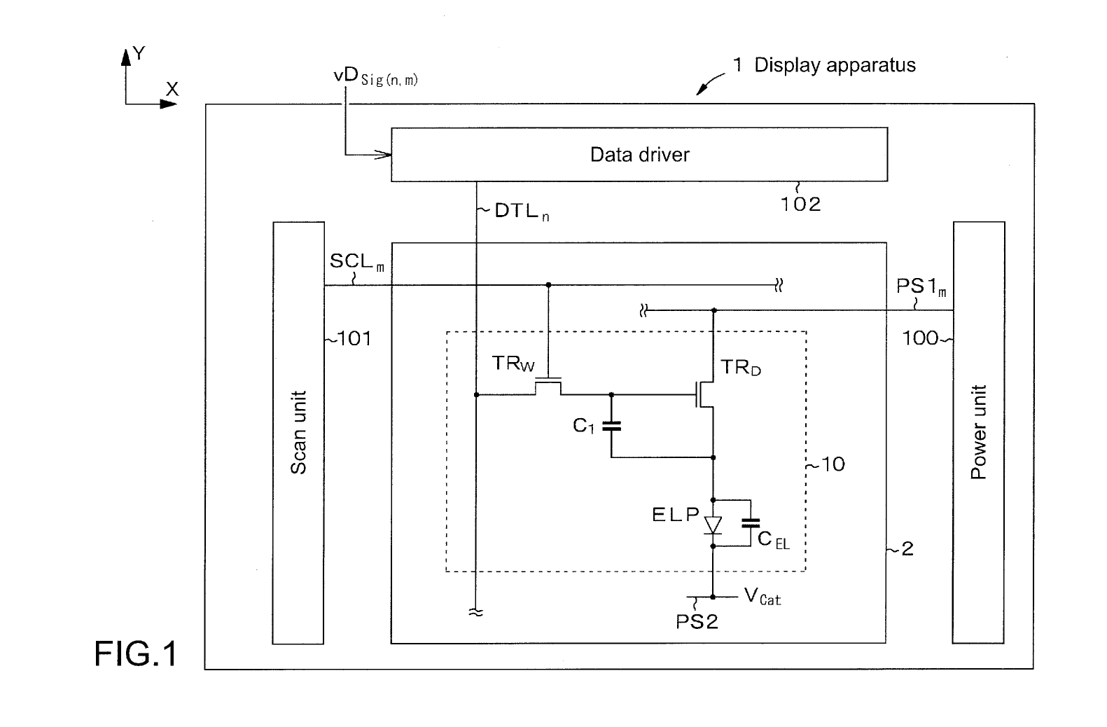

The data driver may have a configuration in which the constituent parts are integrated in one device, or may be configured as separate devices, as appropriate. The reference voltage section and the resistance circuit may be made by using, for example, known circuit elements such as resistors and op amps. Further, a variety of circuits making up the selector section may be made of known circuits such as memory circuits and logic circuits, also using the known circuit elements. In addition, a scan unit and a power unit shown in FIG. 1, which will be described later, may also be made by using the known circuit elements.

Examples of a display panel that may be used in a display apparatus of the present disclosure include known display panels such as liquid crystal display panels and electroluminescent display panels. The configuration of the display panel is not especially limited unless it does not interfere with the operation of the display apparatus.

The display panel may be configured in a so-called monochrome display, or a color display. In cases where the color display is employed, the display panel may have a configuration in which one pixel contains a plurality of sub-pixels, and specifically, in which one pixel contains a red light emitting sub-pixel, a green light emitting sub-pixel, and a blue light emitting sub-pixel. Further, it may have a configuration in which the pixel has a set of sub-pixels which contains one or more additional sub-pixels in addition to the above-mentioned three sub-pixels (for example, a set in which a sub-pixel that emits white light for improving luminance is added, one in which a sub-pixel that emits complementary color light for widening the color reproduction range is added, one in which a sub-pixel that emits yellow color light for widening the color reproduction range is added, or one in which sub-pixels that emit yellow and cyan color light for widening the color reproduction range are added).

Examples of the pixel number of the display panel may include, but are not limited to, some resolution for image display such as U-XGA (1600, 1200), HD-TV (1920, 1080), Q-XGA (2048, 1536), and others such as (3840, 2160) and (7680, 4320).

The various conditions given herein are satisfied when the conditions are substantially satisfied as well as when the conditions are strictly satisfied in a mathematic sense. The presence of various variations which occur in design or production is permissible.

In timing charts used in the following description, a length of an abscissa showing each period (time length) is only schematic and is not indicative of a rate of the time length of each period. The same holds true for an ordinate. Further, the shapes of the waveforms in the timing charts are also only schematic.

### First Embodiment

The “first embodiment” relates to a data driver and a display apparatus having such a data driver according to the first embodiment of the present disclosure.

FIG. 1 is a schematic diagram showing the display apparatus according to the first embodiment. A display apparatus 1 includes a display panel 2 and a data driver 102. The display panel 2 is provided with scan lines SCL each extending in row-direction (X-direction of FIG. 1), data lines DTL each extending in column-direction (Y-direction of FIG. 1), and display elements 10 arranged in the state of a 2-dimensional matrix connected to the scan lines SCL and to the data lines DTL, the display elements 10 each including a current-driven light emitting part and a drive circuit configured to drive the light emitting part. The data driver 102 applies a voltage to the data lines DTL. To the scan lines SCL, a scan signal is supplied from a scan unit 101. The light emitting part that makes up each display element 10 may include, for example, an organic electroluminescence light emitting part. It should be noted that FIG. 1 shows just one of the display elements 10, for convenience of illustration in the figure. More specifically, the figure shows the connection relation for the (n, myth display element 10, which will be described later.

The display panel 2 further includes power supply lines PS1 each connected to the display elements 10 arrayed in a row, and a second power supply line PS2 to which all of the display elements 10 are commonly connected. To the power supply lines PS1, a predetermined drive voltage is supplied from a power unit 100. The second power supply line PS2 is provided with a common voltage (for example, grounding potential).

Although not shown in FIG. 1, an area where the display panel 2 displays the image (display area) is made up of the display elements 10 arranged in the state of a 2-dimensional matrix of N in a row, M in a column, and N×M elements in total. The number of the rows of the display elements 10 in the display area is M, and the number of the display elements 10 in each row is N.

The number of the scan lines SCL and the number of the power supply lines PS1 are both M. The display elements 10 of the m-th row (m=1, 2, . . . , M) are connected to the m-th scan line SCLₘ and the m-th power supply line PS1ₘ, and together they make up one display element line. It should be noted that FIG. 1 shows only the m-th power supply line PS1ₘ.

The number of the data lines DTL is N. The display elements 10 of the n-th column (n=1, 2, . . . , N) are connected to the n-th data line DTLₙ. It should be noted that FIG. 1 shows only the n-th data line DTLₙ.

The display apparatus 1 may be, for example, a monochrome display apparatus, in which one display element 10 makes up one pixel. The display apparatus 1 is subjected to line-by-line sequential scanning by the scan signal from the scan unit 101. The display element 10 of the m-th row and n-th column will be hereinafter referred to as “(n, m)th display element 10” or “(n, m)th pixel”.

In the display apparatus 1, the display elements 10 making up N pixels arranged in the m-th row are driven at the same time. In other words, timing of emission and non-emission of the N display elements 10 disposed along the row-direction is controlled line-by-line, according to the row to which they belong. With display frame rate of the display apparatus expressed in FR (frames/second), a scanning period for each row in line-by-line sequential scanning of the display apparatus 1 (a so-called horizontal scanning period) will be equal to or less than (1/FR)×(1/M) seconds.

To the data driver 102 of the display apparatus 1, a gradation signal vD_{Sig} corresponding to the image to be displayed is input, for example, from a device which is not shown in the drawing. The gradation signal corresponding to the (n, myth display element 10 among the input gradation signals vD_{sig} may be expressed as vD_{sig(n, m)} or vD_{sig}_{_{—}}ₘ. An image signal voltage V_{sig} that the data driver 102 applies to the data line DTI, on the basis of the value of the vD_{sig(n, m)} may be expressed as V_{sig(n, m)} or V_{sig}_{_{—}}_{m.}

For convenience of illustration, suppose that a gradation bit number of the gradation signal vD_{sig (n, m)} is 4 bits. The gradation value may be a value from 0 to 15, depending on the luminance of the image to be displayed.

In this case, a larger gradation value indicates higher luminance of the image to be displayed. It should be noted that the above-mentioned gradation bit number is only illustrative. It may be configured with other gradation bit numbers such as 8 bits, 12 bits, 16 bits and 24 bits.

The display element 10 includes at least a current-driven light emitting part ELP, a write transistor TR_{W}, a drive transistor TR_{D} and a capacitor C₁, and is configured to emit light when a current flows to the light emitting part ELP through source/drain regions of the drive transistor TR_{D}.

The capacitor C₁ is used for holding a voltage of a gate electrode with respect to the source region of the drive transistor TR_{D} (a so-called gate-to-source voltage). In the light-emitting state of the display element 10, a first source/drain region of the drive transistor TR_{D} (the side connected to the power supply line PS1 in FIG. 1) serves as the drain region, and a second source/drain region (the side connected to one terminal of the light emitting part ELP, specifically, connected to an anode electrode) thereof serves as the source region. A first electrode and a second electrode making up the capacitor C₁ are connected to the second source/drain region of the drive transistor TR_{D} and the gate electrode, respectively. The write transistor TR_{W} has a gate electrode connected to the scan line SCL, a first source/drain region connected to the data line DTL, and a second source/drain region connected the gate electrode of the drive transistor TR_{D}.

The gate electrode of the drive transistor TR_{D} is connected to the second source/drain region of the write transistor TR_{W} and the second electrode of the capacitor C₁. The second source/drain region of the drive transistor TR_{D} is connected to the first electrode of the capacitor C₁ and the anode electrode of the light emitting part ELP.

The other terminal of the light emitting part ELP (specifically, a cathode electrode) is connected to the second power supply line PS2. The reference symbol C_{EL} represents a capacitance of the light emitting part ELP. In a state where the voltage corresponding to the luminance of the image to be displayed is supplied from the data driver 102 to the data line DTL, when the write transistor TR_{W} is switched to a conductive state by the scan signal from the scan unit 101, the voltage corresponding to the luminance of the image to be displayed is written into the capacitor C₁. After the write transistor TR_{W} is switched to a non-conductive state, a current according to the voltage held by the capacitor C₁ flows through the drive transistor TR_{D}, and the light emitting part ELP emits the light.

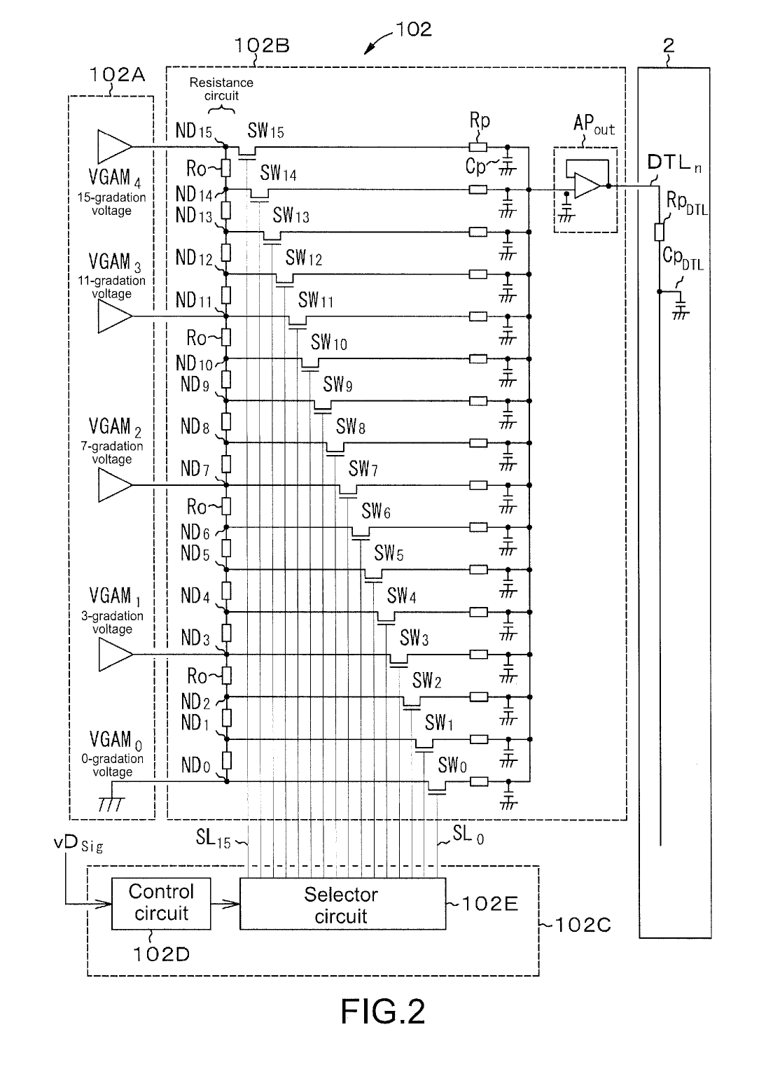

FIG. 2 is a schematic circuit diagram for explaining a configuration of the data driver of a part which contributes to driving the n-th data line.

The configuration of the data driver 102 will now be described in detail. The data driver 102 includes a reference voltage section 102A, resistance circuits, and a selector section 102C.

The reference voltage section 102A has at least three kinds of reference voltage sources configured to supply their respective reference voltages, the reference voltage sources being arranged in descending or ascending order of voltage values.

Each resistance circuit has a plurality of voltage division nodes connected between adjacent reference voltage sources, the voltage division nodes dividing the reference voltages.

The selector section 102C is configured to select and allow output of one voltage among the reference voltages or the voltages of the voltage division nodes, the voltage corresponding to an input value of a gradation signal vD_{sig}.

In the case shown in FIG. 2, the reference voltage section 102A is configured to supply five kinds of reference voltages represented by the reference symbols from VGAM₂ to VGAM₄. The reference voltages are set to satisfy the order of voltage values as follows: VGAM₄>VGAM₂>VGAM₂>VGAM₄>VGAM₂. These reference voltages may be supplied by, for example, op amps or the like, and the output impedance of the reference voltage section 102A is low.

Each resistance circuit is made up of a plurality of resistors denoted by the reference symbol Ro connected in series, disposed between the adjacent reference voltage sources. The reference symbol 102B denotes a part following the resistance circuits within the data driver 102.

In the case shown in FIG. 2, in each part between the reference voltage sources VGAM₄ and VGAM₃; VGAM₃ and VGAM₂; and VGAM₂ and VGAM₁, a set of four resistors Ro is connected in series. In the part between the reference voltage sources VGAM₄ and VGAM₂, a set of three resistors

Ro is connected in series.

The resistance circuit made up of the four resistors Ro connected in series between the reference voltage sources VGAM₄ and VGAM₃ has voltage division nodes ND₁₂, ND₁₃ and ND₁₄ dividing the reference voltages. A connecting point connecting the reference voltage source VGAM₄ and the resistance circuit is represented by a node ND₁₅, and a connecting point connecting the reference voltage source VGAM₃ and the resistance circuit is represented by a node ND₁₁.

Similarly, the resistance circuit made up of the four resistors Ro connected in series between the reference voltage sources VGAM₃ and VGAM₂ has voltage division nodes ND₁₀, ND₉ and ND₈ dividing the reference voltages. For convenience of illustration, a connecting point connecting the reference voltage source VGAM₂ and the resistance circuit is represented by a node ND₇.

Similarly, the resistance circuit made up of the four resistors Ro connected in series between the reference voltage sources VGAM₂ and VGAM₁ has voltage division nodes ND₆, ND_{S} and ND₄ dividing the reference voltages. For convenience of illustration, a connecting point connecting the reference voltage source VGAM₁ and the resistance circuit is represented by a node ND₃.

The resistance circuit made up of the three resistors Ro connected in series between the reference voltage sources VGAM₁ and VGAM₀ has voltage division nodes ND₂ and ND₁ dividing the reference voltages. For convenience of illustration, a connecting point connecting the reference voltage source VGAM_{O} and the resistance circuit is represented by a node ND₉. In addition, in the following description, the “voltage division node” may be simply referred to as “node”.

For convenience of illustration, the values of the reference voltages VGAM₄, VGAM₃, VGAM₂, VGAM₁ and VGAM₀ are set, respectively, to 15, 11, 7, 3 and 0 [volt], and the values of the plurality of resistors Ro are set to a substantially constant value. In this case, the voltages of the nodes ND₁₅ to ND₀, respectively, are 15 to 0 [volt] in which the potential difference between adjacent nodes is 1 [volt]. In other words, the voltages of the respective nodes ND are set to change linearly. It should be noted, however, that the present disclosure is not limited to such a configuration. For example, the voltages of the respective nodes ND may be set to change in a non-linear manner such that it can compensate the non-linearity in the characteristics of the display panel.

The nodes ND₁₅ to ND₀ may be connected to an input side of an output amplifier APₒᵤₜ through respective switches SW₁₅ to SW₀ made of transistors, for example. The conduction/non-conduction of the switches SW₁₅ to SW₀ may be controlled by signals from the selector section 102C supplied thereto through respective control lines SL₁₅ to SL₀.

Basically, when an image of the gradation value of 15 is to be displayed, the switch SW₁₅ is selected so that the node ND₁₅ is connected to the input side of the output amplifier APₒᵤₜ. When an image of the gradation value of 14 is to be displayed, the switch SW₁₄ is selected so that the node ND₁₄ is connected to the input side of the output amplifier APₒᵤₜ. When an image of the gradation value of 13 is to be displayed, the switch SW₁₃ is selected so that the node ND₁₃ is connected to the input side of the output amplifier APₒᵤₜ. It operates in the same manner when images of other gradation values are to be displayed.

An output side of the output amplifier APₒᵤₜ is connected to the data line DTLₙ of the display panel 2.

The data line DTLₙ is accordingly driven by the image signal voltage V_{sig} that the output amplifier APₒᵤₜ outputs. The reference symbols Rp_{DTL} and Cp_{DTL}, respectively, represent a parasitic resistance and a parasitic capacitance of the data line.

Now, in order to facilitate the understanding of the present disclosure, an operation in a case where the reference voltage is selected and output, and that in a case where the voltage of the voltage division node is selected and output, will be described.

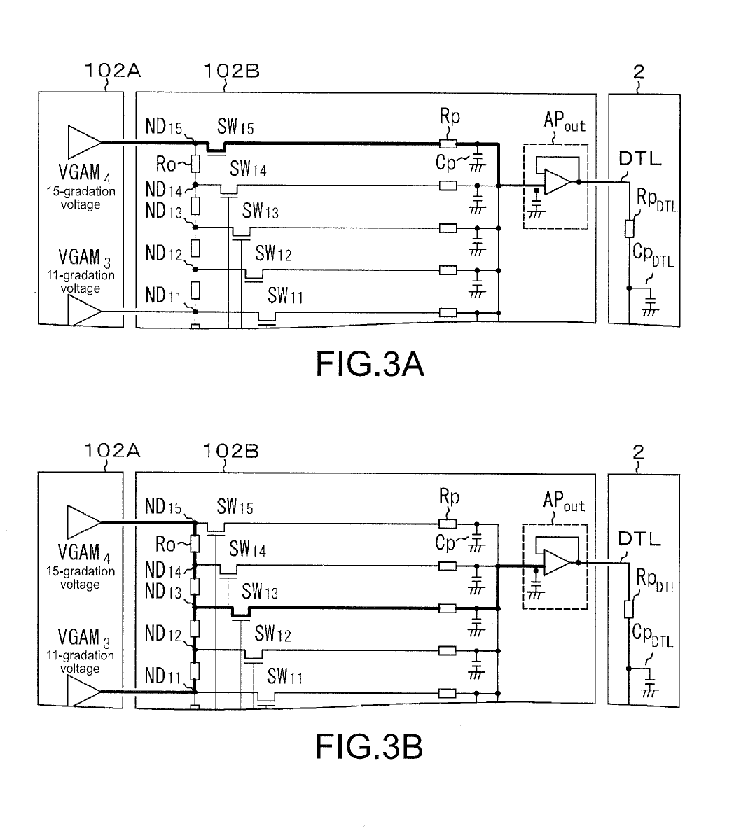

FIG. 3A is a schematic circuit diagram for explaining the operation in the case where the reference voltage is selected and output. FIG. 3B is a schematic circuit diagram for explaining the operation in the case where the voltage of the voltage division node is selected and output.

FIG. 3A schematically shows the case where the reference voltage VGAM₄ is selected and output. In this case, no resistor Ro forming the resistance circuit is interposed in the path from the node ND₁₅ to the input side of the output amplifier APₒᵤₜ. Therefore, mainly, the parasitic resistance Rp_{DTL} and the parasitic capacitance Cp_{DTL} in the path may affect signal propagation.

FIG. 3B schematically shows the case where the voltage of the voltage division node ND₁₃ is selected and output. In this case, some resistors Ro forming the resistance circuit are interposed in the path from the node ND₁₃ to the input side of the output amplifier APₒᵤₜ. Therefore, as well as the parasitic resistance Rp_{DTL} and the parasitic capacitance Cp_{DTL} in the path, the resistors Ro may also affect signal propagation. Qualitatively, the delay of the signal is greater than that in FIG. 3A.

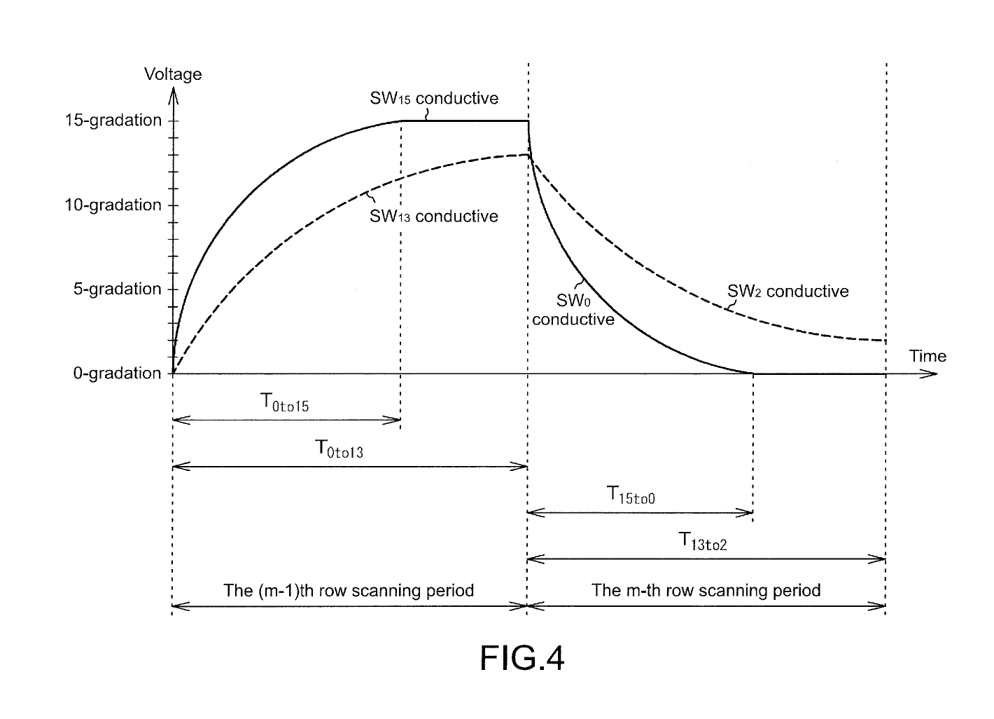

FIG. 4 is a schematic graph for explaining a change in voltage at the input part of the output amplifier in the case where the reference voltage is selected and output; and a change in voltage at the input part of the output amplifier in the case where the voltage of the voltage division node is selected and output.

For example, suppose a case where the gradation value is 0 in the scanning period of the (m-2)th row, and when the switch SWₙ is made conductive and then the switch SWₙ is made non-conductive while the switch SW₀ is made conductive, for making the gradation value of 15 in the scanning period of the (m-1)th row and for making the gradation value of 0 in the scanning period of the m-th row. In this case, the reference voltage VGAM₄ and VGAM₀ will be selected successively. The voltage at the input side of the output amplifier APₒᵤₜ changes in such a manner as the solid-line waveform of FIG. 4. The reference symbols T₀ₜₒ₁₅ and T_{15 to0} indicate settling times for making the gradation value of 15 and for making the gradation value of 0, respectively.

Meanwhile, suppose a case where the gradation value is 0 in the scanning period of the (m-2)th row, and when the switch SW₁₃ is made conductive and then the switch SW₁₃ is made non-conductive while the switch SW₂ is made conductive, for making the gradation value of 13 in the scanning period of the (m-1)th row and for making the gradation value of 2 in the scanning period of the m-th row. In this case, since the voltages of the voltage division nodes ND₁₃ and ND₂ are selected successively, the delay in the waveform increases, and the voltage at the input side of the output amplifier APₒᵤₜ changes in such a manner as the dashed-line waveform of FIG. 4. The reference symbols T₀ₜₒ₁₃ and T₁₃ₜₒ₂ indicate settling times for making the gradation value of 13 and for making the gradation value of 2, respectively.

As illustrated in FIG. 4, in cases where the voltage of the voltage division node is selected, the settling time would become relatively longer than that in cases where the reference voltage is selected. Accordingly, in order to realize high speed in the data driver, it may be necessary to shorten the settling time when selecting the voltage of the voltage division node.

In the present disclosure, when the voltage to be output corresponding to the value of the gradation signal is one of the voltages of the voltage division nodes, the selector section selects one of two reference voltages from two reference voltage sources being connected to the resistance circuit including a corresponding voltage division node, and subsequently selects the voltage of the corresponding voltage division node.

With this operation, for example, in comparison to successively selecting the voltages of the voltage division nodes during a predetermined scanning period, the rise/fall of the waveform can be made steeper. Thus, it is possible to shorten the settling time.

Here, it may be configured such that when the voltage to be output corresponding to the value of the gradation signal is the voltage of the voltage division node, the selector section selects one reference voltage which shows an overshoot with respect to the voltage to be output, from two reference voltages, and subsequently selects the voltage of the corresponding voltage division node. Alternatively, it may be configured such that the selector section selects one reference voltage which shows an undershoot with respect to the voltage to be output, from two reference voltages, and subsequently selects the voltage of the corresponding voltage division node. From the viewpoint of shortening the settling time, the former configuration may be favorable. From the viewpoint of stability in the waveform, the latter configuration may be favorable.

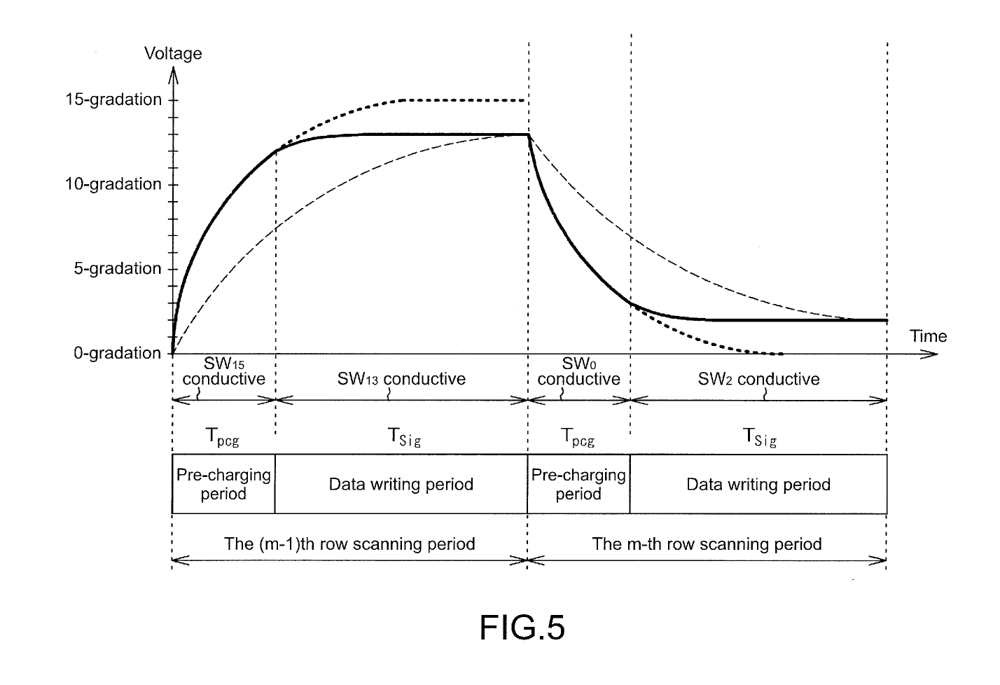

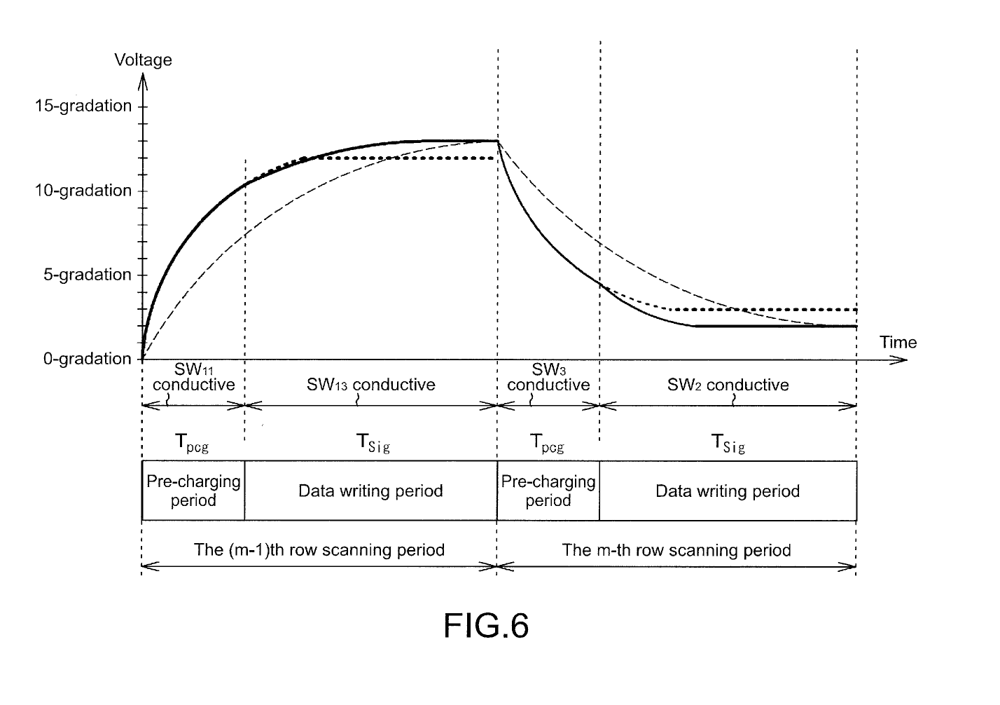

In the following, a basic operation of this embodiment will be described with reference to FIGS. 5 and 6.

FIG. 5 is a schematic graph for explaining a change in voltage at the input part of the output amplifier in the case where a selector section selects the reference voltage which shows an overshoot with respect to the voltage to be output, from two reference voltages, and subsequently selects the voltage of the corresponding voltage division node.

On the other hand, FIG. 6 is a schematic graph for explaining a change in voltage at the input part of the output amplifier in the case where the selector section selects the reference voltage which shows an undershoot with respect to the voltage to be output, from two reference voltages, and subsequently selects the voltage of the corresponding voltage division node.

First, an explanation will be given with reference to FIG. 5. In the case shown in FIG. 5, when the gradation value is 0 in the scanning period of the (m-2)th row, first, the reference voltage VGAM₄ is selected, and subsequently the voltage of the voltage division node ND₁₃ is selected, for making the gradation value of 13 in the scanning period of the (m-1)th row and for making the gradation value of 2 in the scanning period of the m-th row. More specifically, by the operation of the selector section 102C, the switch SW₁₅ is made conductive only for a period T_{pcg} and then the switch SW₁₃ is made conductive only for a period T_{sig}. It should be noted that the sum of the periods T_{pcg} and T_{sig} corresponds to the scanning period of the (m-1)th row. After that, by the operation of the selector section 102C, the switch SW₀ is made conductive only for a period T_{pcg} and then the switch SW₂ is made conductive only for a period T_{sig}. At the beginning of the scanning period of the (m-1)th row, since the reference voltage VGAM₄ is selected, the change in the waveform becomes steeper than that in the case of selecting the voltage of the voltage division node of the resistance circuit. This operation may be considered as pre-charging of the path connected to the input side of the output amplifier APₒᵤₜ; therefore, the period T_{pcg} will be referred to as “pre-charging period” herein. After the pre-charging period T_{pcg} is finished, the voltage division node ND₁₃ is selected during the period T_{sig}, and the voltage continues to change towards the target value to reach the predetermined voltage. The period T_{sig} will be referred to as “data writing period” herein.

Further, at the beginning of the scanning period of the m-th row, since the reference voltage VGAM₀ is selected, the change in the waveform becomes steeper than that in the case of selecting the voltage of the voltage division node ND. After the pre-charging period T_{pcg} is finished, the voltage division node ND₂ is selected during the period T_{sig}, and the voltage continues to change towards the target value to reach the predetermined voltage. As a result, the waveform of the voltage becomes the waveform indicated by the thick solid line in FIG. 5. It should be noted that in FIG. 5, the thick finely dashed line in the scanning period of the (m-1)th row indicates the waveform when continued to select the reference voltage VGAM₄ in the period T_{sig}; and the thick finely dashed line in the scanning period of the m-th row indicates the waveform when continued to select the reference voltage VGAM₄ in the period T_{sig}.

FIG. 5 shows the waveform of the graph shown in the dashed line in FIG. 4 in an overlaid manner, for comparison. As is evident from the comparison of the thick solid-line waveform and the dashed-line waveform in FIG. 5, the operation shown in FIG. 5 shortened the time to reach the target voltage. Therefore, reduction of the settling time is achieved.

In the case shown in FIG. 5, the selector section 102C selects the reference voltage in the pre-charging period in one scanning period (horizontal scanning period), and subsequently selects the voltage of the voltage division node in the data writing period longer than the pre-charging period in the same horizontal scanning period. This means that the relation between the periods is T_{pcg}<T_{sig}. The same holds true for a case shown in FIG. 6 which will be described later. In this embodiment, usually, this configuration may be desirable. The same holds true for a second embodiment which will be described later.

In addition, it may be configured such that the values of the pre-charging period T_{pcg} and/or the values of data writing period T_{sig} vary depending on the voltage division nodes to be selected. For example, the values of the periods T_{pcg} and T_{sig} may be selected as appropriate based on experiments by an actual machine, or the like. Further, if it does not interfere with the operation, it may be configured such that the periods T_{pcg} and T_{sig} are fixed to certain predetermined values.

Next, an explanation will be given with reference to FIG. 6. The operation shown in FIG. 6 is different from the above in that the reference voltage VGAM₃ is selected in the pre-charging period T_{pcg} in the scanning period of the (m-1)th row; and that the reference voltage VGAM₁ is selected in the pre-charging period T_{pcg} in the scanning period of the m-th row.

It should be noted that in FIG. 6, the thick finely dashed line in the scanning period of the (m-1)th row indicates the waveform when continued to select the reference voltage VGAM₃ in the period T_{sig}; and the thick finely dashed line in the scanning period of the m-th row indicates the waveform when continued to select the reference voltage VGAM₁ in the period T_{sig}.

In the operation of FIG. 6, the change in the waveform becomes gentler than that in the operation of FIG. 5. Accordingly, from the viewpoint of shortening the settling time, the operation of FIG. 5 may be favorable. However, in the operation shown in FIG. 5, a phenomenon of an overshoot of the waveform might occur in cases where the setting of the pre-charging period was not appropriate. In contrast, in the operation shown in FIG. 6, the overshoot of the waveform does not occur in principle. Thus, from the viewpoint of stability in the waveform, the operation of FIG. 6 may be favorable.

The above is the description of the basic operation of this embodiment. The first embodiment may be implemented as various modes of embodiments in terms of control. For example, it may be in a mode such that, in order to drive the (n, m)th pixel, the control is carried out by referring only to the gradation signal vD_{sig}_{_{—}}ₘ, or carried out by considering also the relation between the gradation signal vD_{sig}_{_{—}}ₘ and the previous gradation signal vD_{sig}_{_{—}}ₘ₋₁. For example, the data driver may further include a table containing data of a length of a period to select the reference voltage, and a length of a period to select the voltage of the corresponding voltage division node, which data corresponds to the input value of the gradation signal. The data driver may be configured such that the selector section selects the reference voltage or the voltage of the voltage division node in a period controlled based on the data contained in the table. The same holds true for a second embodiment which will be described later.

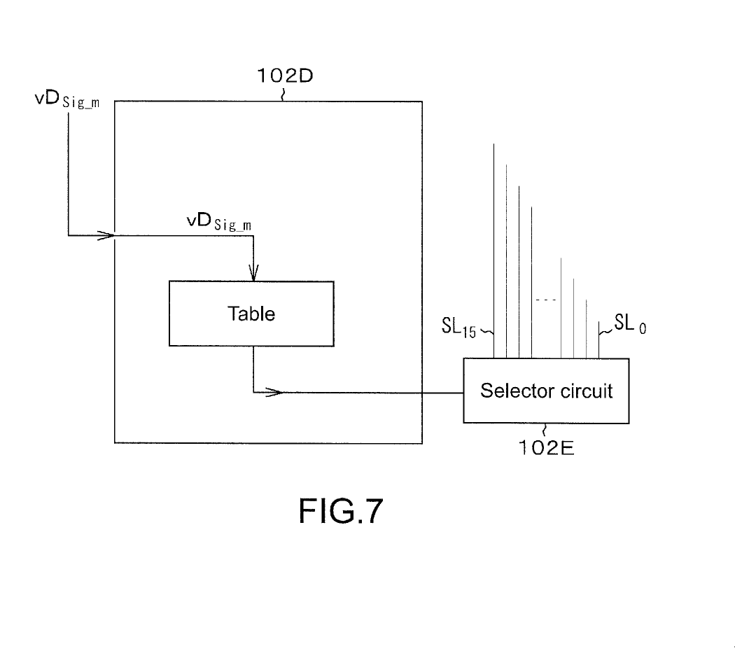

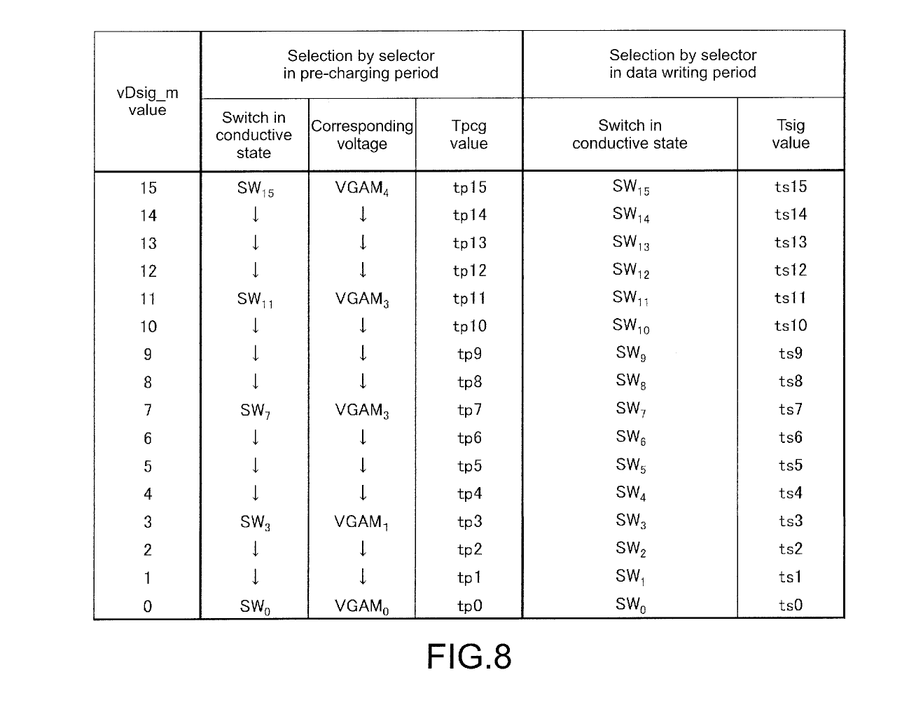

Now, an example of the mode in which, in order to drive the (n, m)th pixel, the control is carried out by referring only to the gradation signal vD_{sig}_{_{—}}ₘ will be described with reference to FIGS. 7 and 8.

FIG. 7 is a schematic diagram for explaining a configuration of a control circuit of the selector section in the first embodiment.

As shown in FIG. 7, the gradation signal vD_{sig}_{_{—}}ₘ is input to a control circuit 102D which makes up the selector section 120C. The control circuit 102D refers to a table on the basis of the gradation signal vD_{sig}_{_{—}}ₘ, and controls a selector circuit 120E according to the result of reference.

FIG. 8 is a table for explaining the configuration and the like, of the table in the first embodiment.

The table may contain the values representing the switches in a conductive state during the pre-charging period, the lengths of the period in which these switches are conductive, the switches in a conductive state during the data writing period and the lengths of the period in which these switches are conductive, corresponding to each value of the gradation signal vD_{sig}_{_{—}}ₘ. The values shown in FIG. 8 of from tp₁₅ to tp₀ and from tsp₁₅ to ts₀ may be selected and set as appropriate based on experiments by an actual machine, or the like.

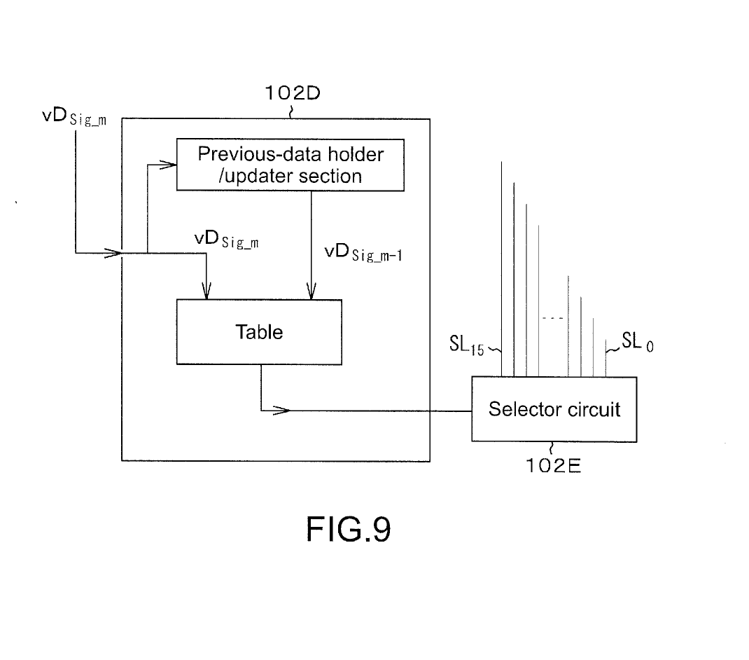

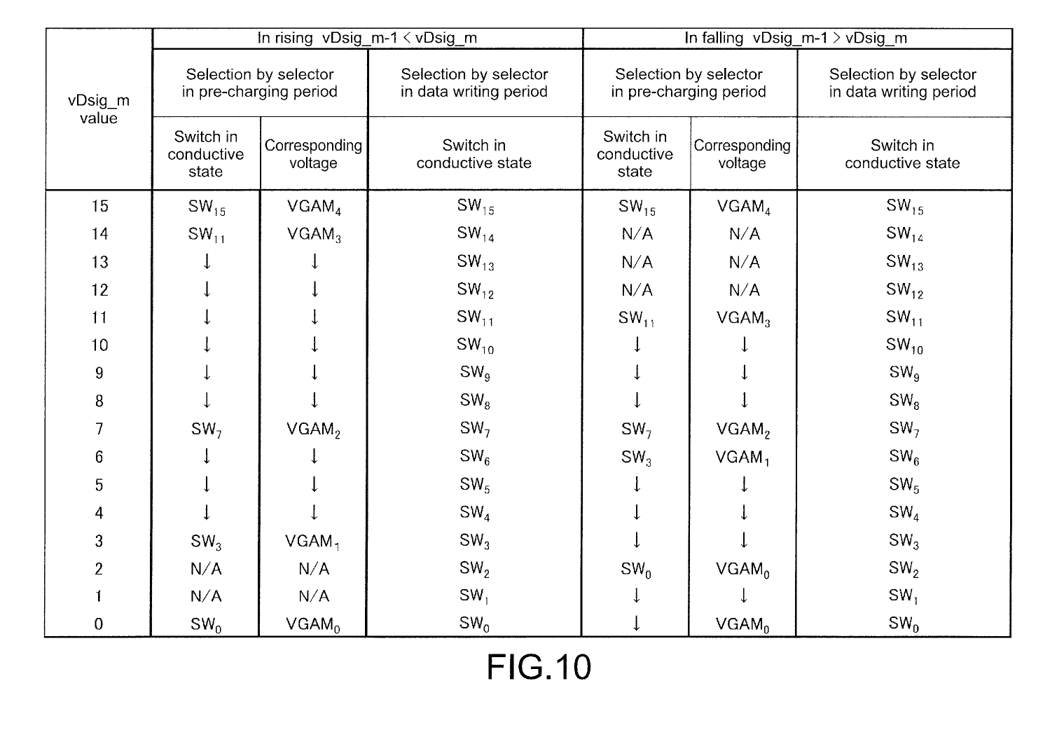

Next, an example of the mode in which the control is carried out by considering the relation between the gradation signal vD_{sig}_{_{—}}ₘ and the previous gradation signal vD_{sig}_{_{—}}ₘ₋₁ will be described with reference to FIGS. 9 and 10.

FIG. 9 is a schematic diagram for explaining a configuration of a control circuit of the selector section in a variation example of the first embodiment.

As shown in FIG. 9, the gradation signal vD_{sig}_{_{—}}ₘ is input to a control circuit 102D which makes up the selector section 120C. The control circuit 102D includes, for example, a previous-data holder/updater section made up of a storage circuit and the like. This stores the previous gradation signal vD_{sig}_{_{—}}ₘ₋₁. The control circuit 102D refers to a table on the basis of the gradation signals vD_{sig}_{_{—}}ₘ₋₁ and vD_{sig}_{_{—}}ₘ, and controls the selector circuit 120E according to the result of reference.

FIG. 10 is a table for explaining the configuration and the like, of the table in the variation example of the first embodiment.

In this example, the control is carried out in different ways depending on rising and falling, on the basis of the size relation between the gradation signals vD_{sig}_{_{—}}ₘ₋₁ and vD_{sig}_{_{—}}ₘ. Although the values tp and ts shown in FIG. 8 are not shown in this figure, in the same manner as the above, for example, the values tp and ts may be selected and set as appropriate based on experiments by an actual machine, or the like.

Incidentally, in cases where the values of the gradation signals vD_{sig}_{_{—}}ₘ₋₁ and vD_{sig}_{_{—}}ₘ are the same, the control may be carried out without the pre-charging period but with the whole period set as the data writing period.

### Second Embodiment

The “second embodiment” relates to a data driver and a display apparatus having such a data driver according to the second embodiment of the present disclosure.

A schematic diagram showing the display apparatus according to the second embodiment will be the same as FIG. 1 except that “display apparatus 1” and “data driver 102” are respectively substituted with “display apparatus 1A” and “data driver 202”. Since the configuration and the operation method of the display panel 2 is the same as in the configuration described in the first embodiment, the explanation thereof will be omitted.

Herein, supposing that the gradation bit number of the gradation signal vD_{sig} is 12 bits (4096 gradations of from 0 to 4095), a basic idea of the second embodiment will be described.

However, in an example of a timing table shown in

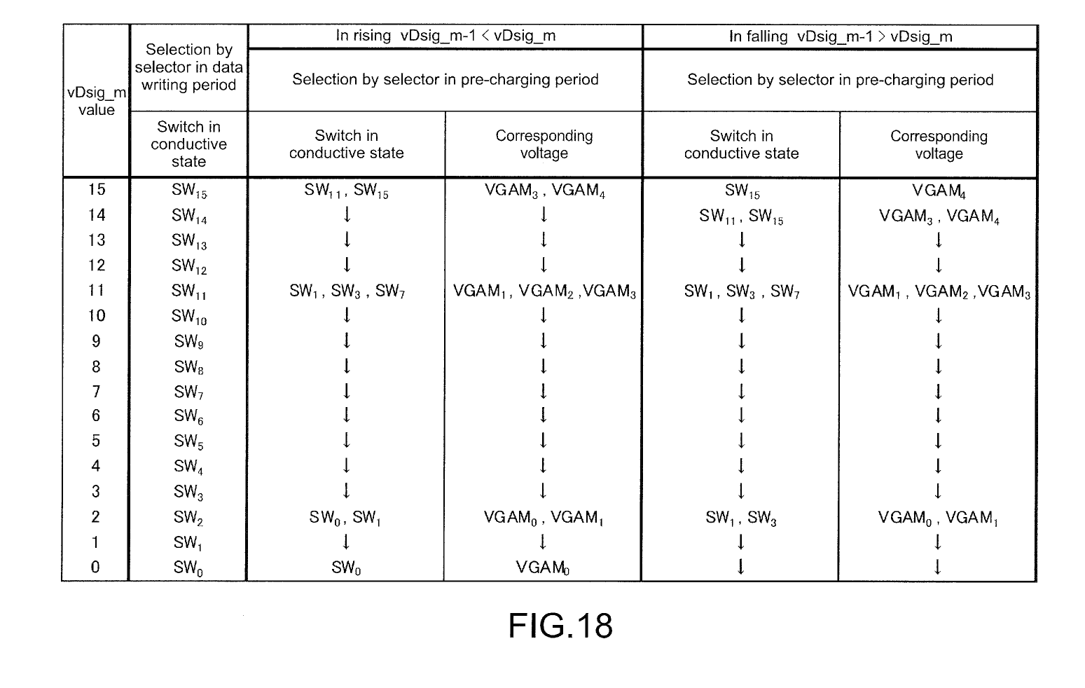

FIG. 18 which will be described later, for convenience of illustration in the figure, the explanation will be given regarding a case where the gradation bit number of the gradation signal vD_{sig} is 4 bits and where the data driver 202 is configured substantially the same as the data driver 102.

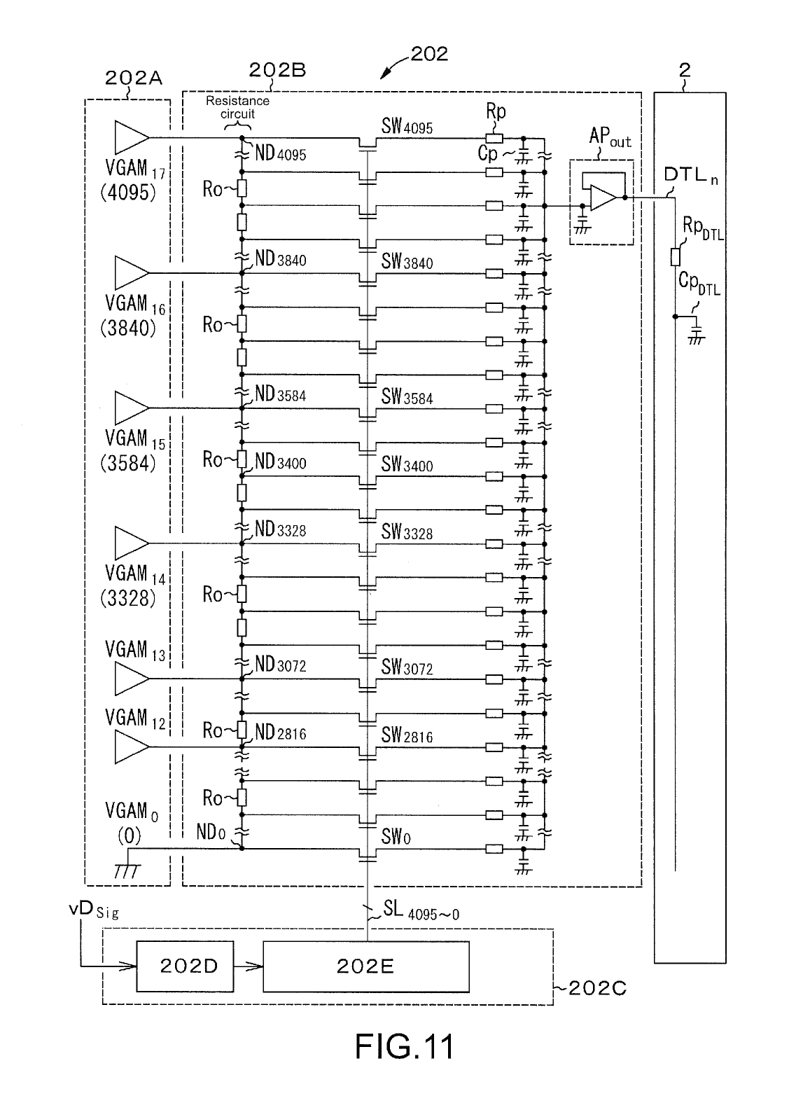

FIG. 11 is a schematic circuit diagram, showing the display apparatus according to the second embodiment, for explaining a configuration of the data driver of a part which contributes to driving the n-th data line.

The configuration of the data driver 202 will now be described in detail. The data driver 202 includes a reference voltage section 202A, resistance circuits, and a selector section 202C.

The reference voltage section 202A has at least three kinds of reference voltage sources configured to supply their respective reference voltages, the reference voltage sources being arranged in descending or ascending order of voltage values.

Each resistance circuit has a plurality of voltage division nodes connected between adjacent reference voltage sources, the voltage division nodes dividing the reference voltages.

The selector section 202C is configured to select and allow output at least one reference voltage, the voltage corresponding to an input value of a gradation signal vD_{sig}.

In the case shown in FIG. 11, the reference voltage section 202A is configured to supply eighteen kinds of reference voltages represented by the reference symbols from VGAM₀ to VGAM₁₇. The reference voltages are set to satisfy the order of voltage values as follows: VGAM₁₇>VGAM₁₆>. . . VGAM₁>VGAM₀. These reference voltages may be supplied by, for example, op amps or the like, and the output impedance of the reference voltage section 202A is low.

Each resistance circuit is made up of a plurality of resistors denoted by the reference symbol Ro connected in series, disposed between the adjacent reference voltage sources. The reference symbol 202B denotes a part following the resistance circuits within the data driver 202.

Between the adjacent reference voltage sources, there are about two hundred and several tens of resistors Ro connected thereto in series. The voltage corresponding to the value of the gradation signal is output from the corresponding node. The reference voltage sources VGAM₁₇, VGAM₁₆, VGAM₁₅, VGAM₁₄, VGAM₁₃, VGAM₁₂, . . . , VGAM₀, respectively, may be configured to output the voltages corresponding to their respective gradation values of 4095, 3840, 3328, 3072, 2816, . . . , 0.

In addition, for example, a node ND₄₀₉₅ represents the node that outputs the voltage corresponding to the gradation value of 4095; and a node ND₀ represents the node that outputs the voltage corresponding to the gradation value of 0.

The nodes ND₄₀₉₅ to ND₀ may be connected to the input side of the output amplifier APₒᵤₜ through respective switches SW₄₀₉₅ to SW₀ made of transistors, for example. The conduction/non-conduction of the switches SW₄₀₉₅ to SW₀ may be controlled by signals from the selector section 102C supplied thereto through respective control lines SL₄₀₉₅ to SL₀. For convenience of illustration in the figure, the figure shows the control lines SL in a simplified manner.

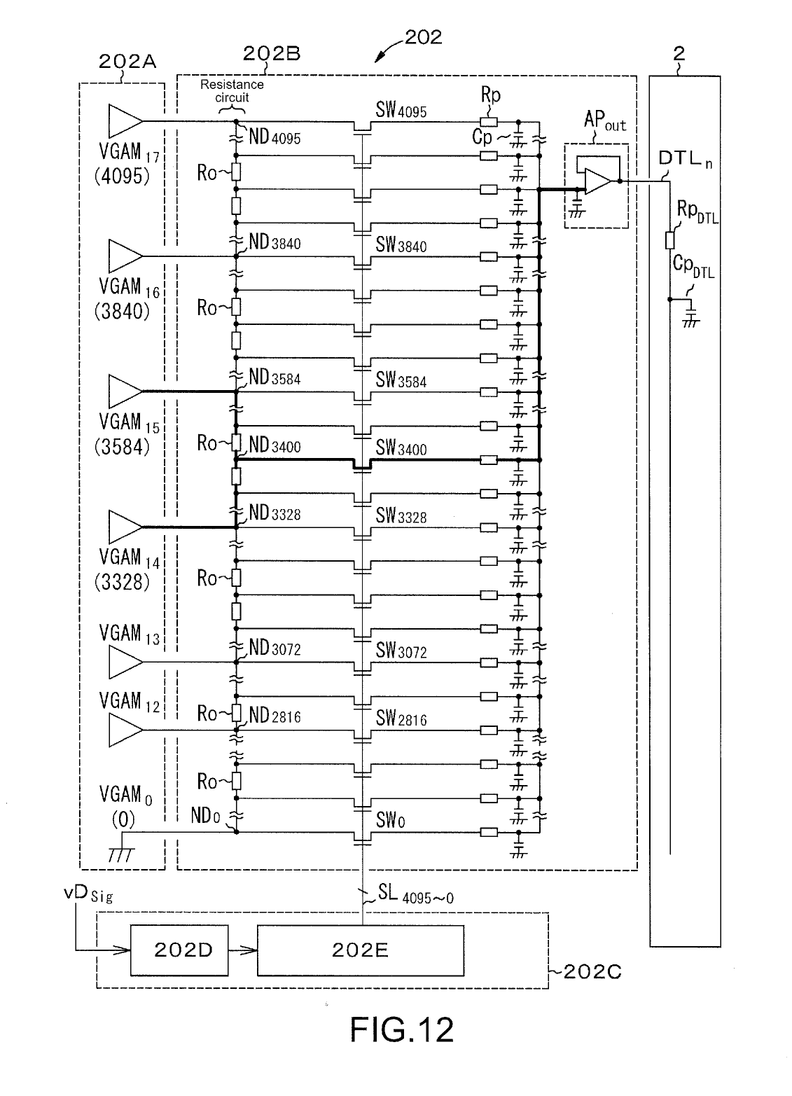

For example, when an image with the gradation value of 3400 was to be displayed in the related technology, simply, a switch SW₃₄₀₀ might be selected, and a node ND₃₄₀₀ might be connected to the input side of the output amplifier APₒᵤₜ (see FIG. 12).

However, in the second embodiment, when the voltage to be output corresponding to the value of the gradation signal is one of the voltages of the voltage division nodes, the selector section selects at least one reference voltage and subsequently select the voltage of the corresponding voltage division node. For example, it may be configured such that the selector section selects at least one reference voltage which shows an overshoot with respect to the voltage to be output. Otherwise, it may be configured such that the selector section selects at least one reference voltage which shows an undershoot with respect to the voltage to be output. In addition, it may be configured such that the selector section selects at least one reference voltage which shows an overshoot with respect to the voltage to be output and at least one reference voltage which shows an undershoot with respect to the voltage to be output.

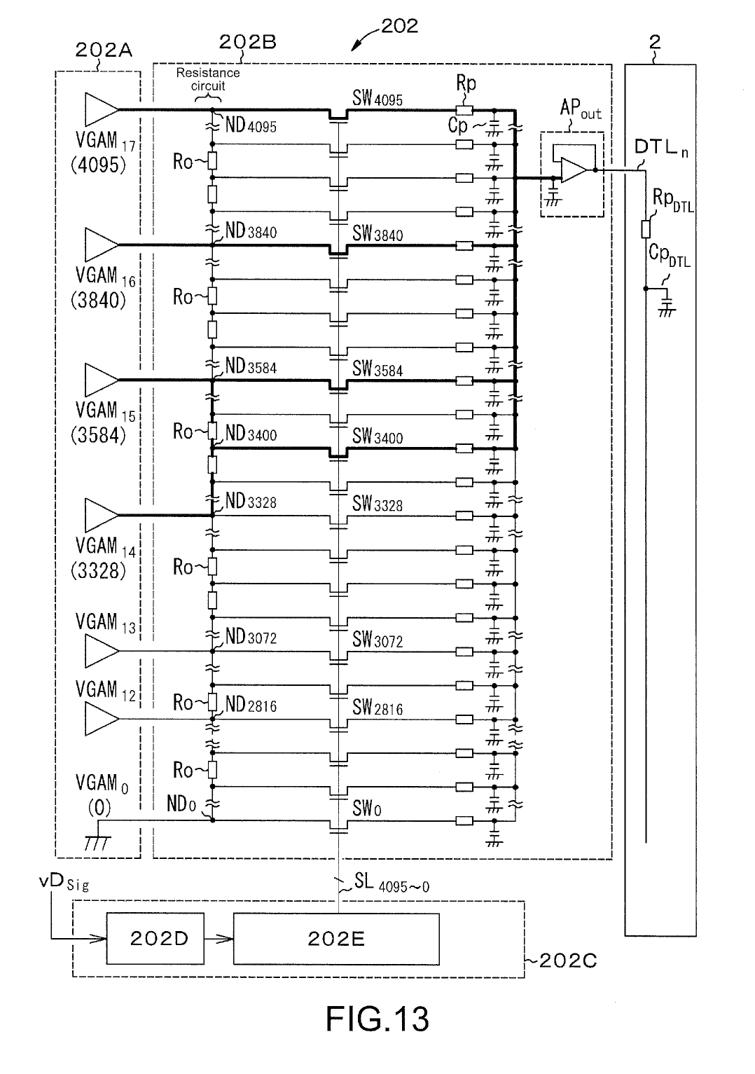

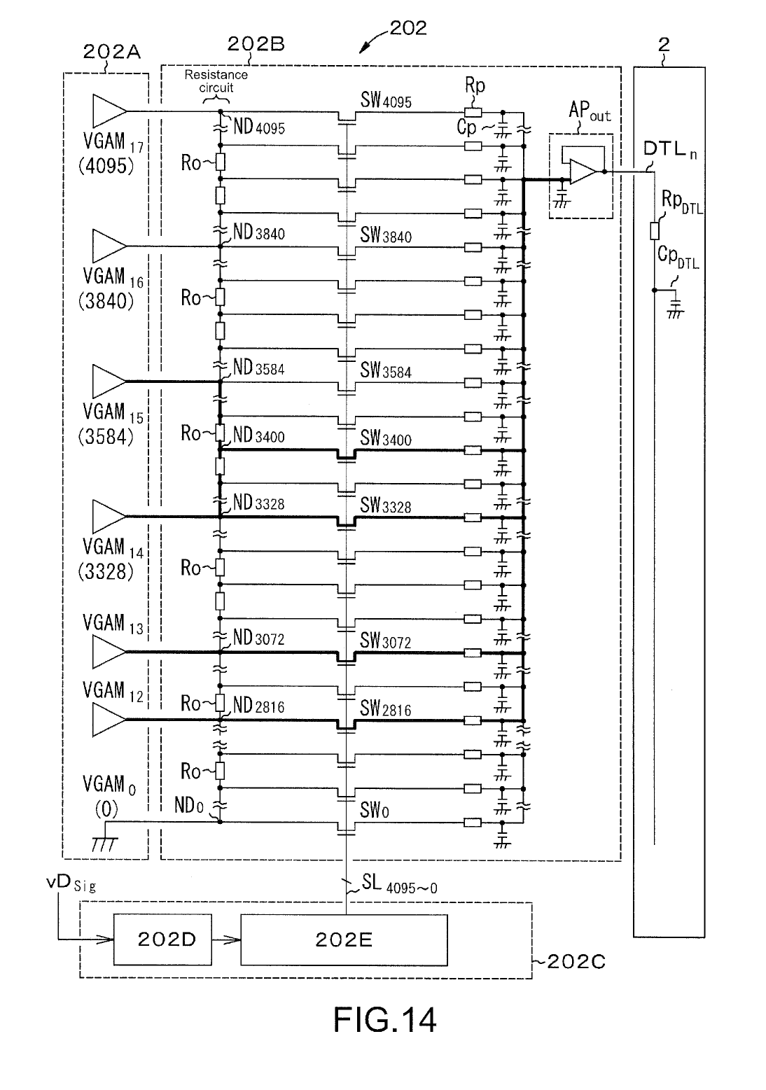

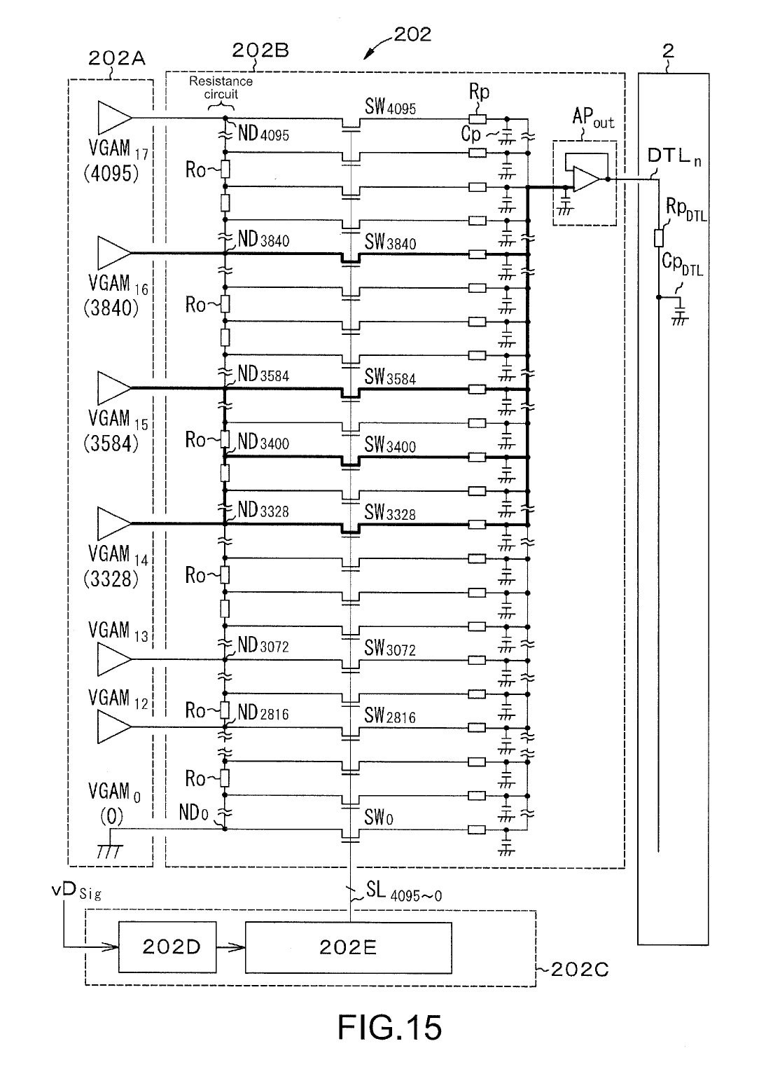

FIG. 13 shows an example of operation for selecting a plurality of reference voltages showing an overshoot, in the case of switching the displayed image from one with the gradation value of 0 to one with the gradation value of 3400. In this example, the reference voltages VGAM₁₅, VGAM₁₆ and VGAM₁₇ are selected and pre-charging is performed. FIG. 14 shows an example of operation for selecting a plurality of reference voltages showing an undershoot. In this example, the reference voltages VGAM₁₂, VGAM₁₃ and VGAM₁₄ are selected and pre-charging is performed. FIG. 15 shows an example of operation for selecting at least one reference voltage showing an overshoot and at least one reference voltage showing an undershoot. In this example, the reference voltages VGAM₁₄, VGAM₁₅ and VGAM₁₆ are selected and pre-charging is performed.

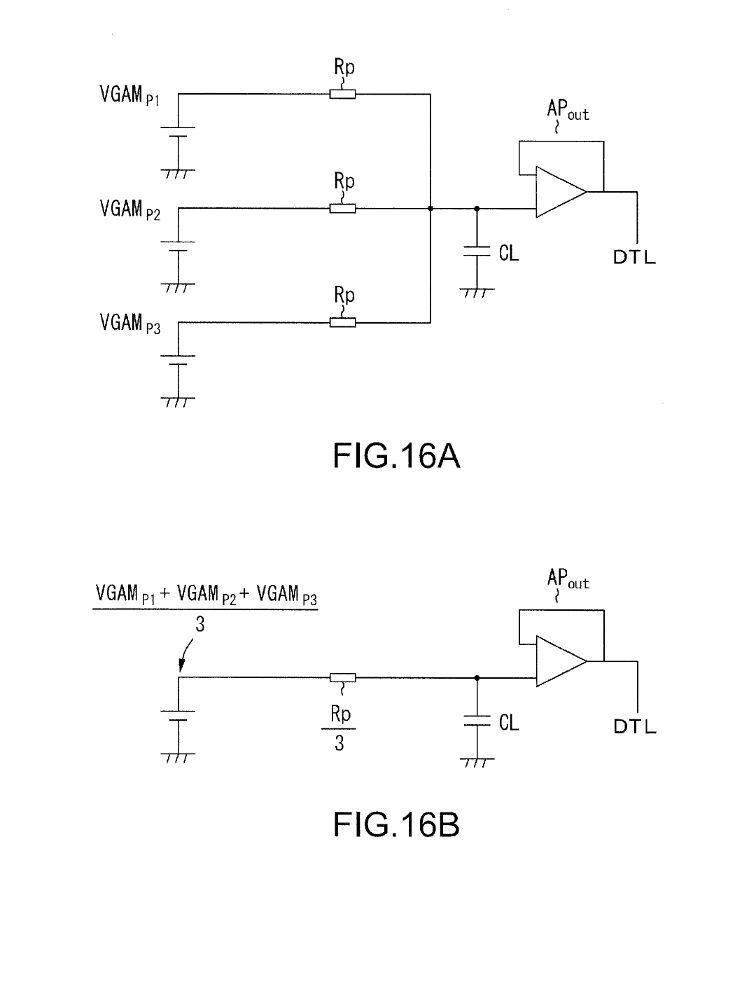

By selecting a plurality of reference voltages, pre-charging may be performed in a shorter time, and thus it is possible to realize high speed in write processing. In the following, an explanation will be given with reference to FIGS. 16A and 16B.

For example, a circuit in performing pre-charging when certain three reference voltages VGAM_{P1}, VGAM_{P2} and VGAM_{P3} are selected may be schematically shown as in FIG. 16A.

In this case, the reference voltages VGAM_{P1}, VGAM_{P2} and VGAM_{P3} are connected to the input side of the output amplifier APₒᵤₜ through the separate individual parasitic resistances Rp. Therefore, three parasitic resistances Rp are, equivalently, in a state of parallel connection with respect to each other.

As shown in a simplified manner, the mean voltage of the reference voltages VGAM_{P1}, VGAM_{P2} and VGAM_{P3} is connected to the input side of the output amplifier APₒᵤₜ through the parasitic resistance of Rp/3 (see FIG. 16B). Thus, a time constant in writing the voltage to the input side of the output amplifier APₒᵤₜ becomes roughly ⅓, and it allows performing pre-charging in a shorter time.

It should be noted that a parasitic resistance Rp is usually a resistance of about several-hundred ohms. There is therefore no hindrance such as a flow of an excess through-current in the circuit supplying the reference voltages, by electrically connecting the output of the reference voltages VGAM_{P1}, VGAM_{P2} and VGAM_{P3} of the different voltage values.

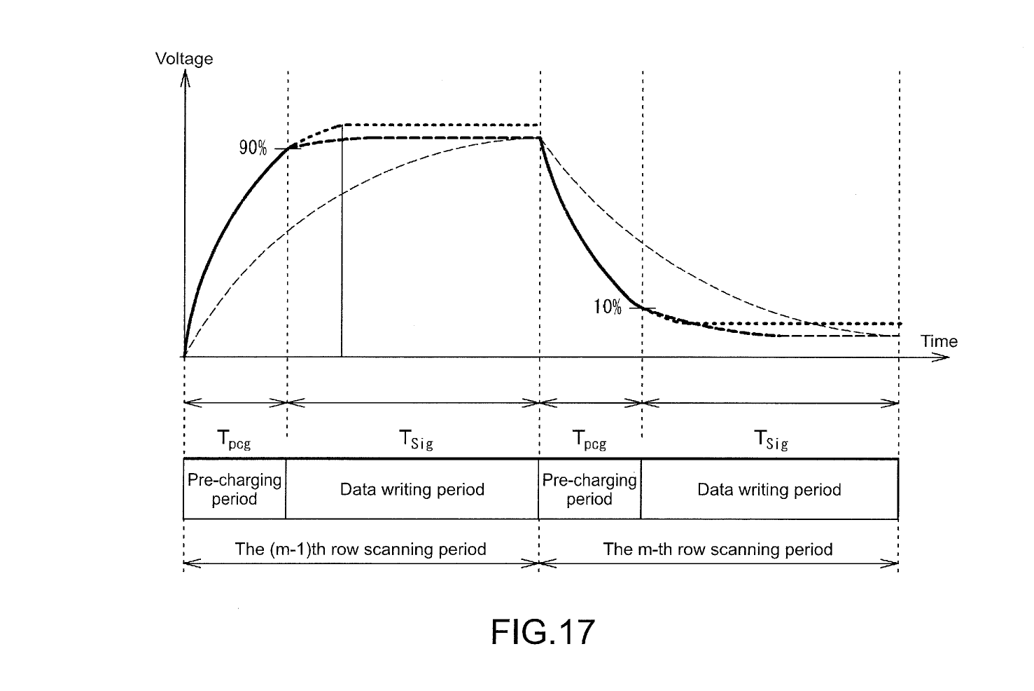

The number of the reference voltages to select at the same time may be selected as appropriate depending on configurations of the display apparatus and the data driver. Typically, as a guide, the number thereof may be appropriately set to several. In some cases, it may be configured to select all of the reference voltages. With reference to FIG. 17, an example of how to select the reference voltages will be described. For example, the number and kinds of the reference voltages may be selected and set as appropriate, based on experiments or the like, so that the value with a difference of about 10% with respect to the target value can be reached in the pre-charging period T_{pcg} that has been determined by specifications.

For example, as described in the first embodiment, it may be in a mode such that the control is carried out by considering the relation between the gradation signal vD_{sig}_{_{—}}ₘ and the previous gradation signal vD_{sig}_{_{—}}ₘ₋₁.

FIG. 18 is a table for explaining the configuration and the like, of the table in a variation example of the second embodiment. As mentioned above, for convenience of illustration in the figure, FIG. 18 shows a case where the gradation bit number of the gradation signal vD_{sig} is 4 bits and where the data driver 202 is configured substantially the same as the data driver 102.

In this example, the control is carried out in different ways depending on rising and falling, on the basis of the size relation between the gradation signals vD_{sig}_{_{—}}ₘ₋₁ and vD_{sig}_{_{—}}ₘ. The number of the reference voltages to select is not constant, and the control may be carried out in such a manner that the states of selecting one reference voltage, two reference voltages, and three reference voltages coexist. Incidentally, in cases where the values of the gradation signals vD_{sig}_{_{—}}ₘ₋₁ and vD_{sig}_{_{—}}ₘ are the same, the control may be carried out without the pre-charging period but with the whole period set as the data writing period.

In addition, in the case shown in FIG. 18, when the voltage to be output corresponding to the value of the gradation signal is the reference voltage, the operation is also carried out by selecting a plurality of reference voltages at the time of pre-charging. This enables to realize high speed also in cases where the voltage to be output corresponding to the value of the gradation signal is the reference voltage.

Although specific embodiments of the present description have been described in detail, it should be noted that the present disclosure is not limited to each of the foregoing embodiments but can be modified in various ways within the scope without departing from the gist of the present disclosure. For example, the numerical values, the configurations and the like in the foregoing embodiments are merely mentioned for illustrative purpose, and different numerical values, configurations and the like may be employed as appropriate.

For example, if an embodiment of the present disclosure employs a configuration in which all of the reference voltages are to be selected in the pre-charging period regardless of the value of the gradation signal, it may allow a prompt setting to a predetermined intermediate voltage in signal writing.

In addition, the present disclosure may employ the following configurations.

[1] A data driver for driving data lines of a display panel, including:
a reference voltage section having at least three kinds of reference voltage sources configured to supply their respective reference voltages, the reference voltage sources being arranged in descending or ascending order of voltage values;
at least one resistance circuit each having a plurality of voltage division nodes connected between adjacent reference voltage sources, the voltage division nodes dividing the reference voltages; and
a selector section configured to select and allow output of one voltage among the reference voltages or the voltages of the voltage division nodes, the voltage corresponding to an input value of a gradation signal,
   the selector section being configured to, when the voltage to be output corresponding to the value of the gradation signal is one of the voltages of the voltage division nodes, select one of two reference voltages from two reference voltage sources being connected to the resistance circuit including a corresponding voltage division node and subsequently select the voltage of the corresponding voltage division node.

[2] The data driver according to [1], in which when the voltage to be output corresponding to the value of the gradation signal is the voltage of the voltage division node, the selector section selects one reference voltage which shows an overshoot with respect to the voltage to be output, from two reference voltages, and subsequently selects the voltage of the corresponding voltage division node.

[3] The data driver according to [1], in which when the voltage to be output corresponding to the value of the gradation signal is the voltage of the voltage division node, the selector section selects one reference voltage which shows an undershoot with respect to the voltage to be output, from two reference voltages, and subsequently selects the voltage of the corresponding voltage division node.

[4] The data driver according to any one of [1] to [3], further including
a table containing data of a length of a period to select the reference voltage, and a length of a period to select the voltage of the corresponding voltage division node, which data corresponds to the input value of the gradation signal;
the selector section being configured to select the reference voltage or the voltage of the voltage division node in a period controlled based on the data contained in the table.

[5] The data driver according to any one of [1] to [4], in which
when the voltage to be output corresponding to the value of the gradation signal is the voltage of the voltage division node, the selector section selects the reference voltage in a pre-charging period in a horizontal scanning period, and subsequently selects the voltage of the corresponding voltage division node in a data writing period longer than the pre-charging period in the same horizontal scanning period.

[6] A display apparatus including:
a display panel; and
a data driver for driving data lines of the display panel, the data driver including

a reference voltage section having at least three kinds of reference voltage sources configured to supply their respective reference voltages, the reference voltage sources being arranged in descending or ascending order of voltage values,
at least one resistance circuit each having a plurality of voltage division nodes connected between adjacent reference voltage sources, the voltage division nodes dividing the reference voltages, and
a selector section configured to select and allow output of one voltage among the reference voltages or the voltages of the voltage division nodes, the voltage corresponding to an input value of a gradation signal,
   the selector section being configured to, when the voltage to be output corresponding to the value of the gradation signal is one of the voltages of the voltage division nodes, select one of two reference voltages from two reference voltage sources being connected to the resistance circuit including a corresponding voltage division node and subsequently select the voltage of the corresponding voltage division node.

[7] The display apparatus according to [6], in which
when the voltage to be output corresponding to the value of the gradation signal is the voltage of the voltage division node, the selector section selects one reference voltage which shows an overshoot with respect to the voltage to be output, from two reference voltages, and subsequently selects the voltage of the corresponding voltage division node.

[8] The display apparatus according to [6], in which
when the voltage to be output corresponding to the value of the gradation signal is the voltage of the voltage division node, the selector section selects one reference voltage which shows an undershoot with respect to the voltage to be output, from two reference voltages, and subsequently selects the voltage of the corresponding voltage division node.

[9] The display apparatus according to any one of [6] to [8], further including
a table containing data of a length of a period to select the reference voltage, and a length of a period to select the voltage of the corresponding voltage division node, which data corresponds to the input value of the gradation signal;
the selector section being configured to select the reference voltage or the voltage of the voltage division node in a period controlled based on the data contained in the table.

[10] The display apparatus according to any one of [6] to [9], in which
when the voltage to be output corresponding to the value of the gradation signal is the voltage of the voltage division node, the selector section selects the reference voltage in a pre-charging period in a horizontal scanning period, and subsequently selects the voltage of the corresponding voltage division node in a data writing period longer than the pre-charging period in the same horizontal scanning period.

[11] A data driver for driving data lines of a display panel, including:
a reference voltage section having at least three kinds of reference voltage sources configured to supply their respective reference voltages, the reference voltage sources being arranged in descending or ascending order of voltage values;
at least one resistance circuit each having a plurality of voltage division nodes connected between adjacent reference voltage sources, the voltage division nodes dividing the reference voltages; and
a selector section configured to select and allow output of one voltage among the reference voltages or the voltages of the voltage division nodes, the voltage corresponding to an input value of a gradation signal,
   the selector section being configured to, when the voltage to be output corresponding to the value of the gradation signal is one of the voltages of the voltage division nodes, select at least one reference voltage and subsequently select the voltage of the corresponding voltage division node.

[12] The data driver according to [11], in which
when the voltage to be output corresponding to the value of the gradation signal is the voltage of the voltage division node, the selector section selects at least one reference voltage which shows an overshoot with respect to the voltage to be output, and subsequently selects the voltage of the corresponding voltage division node.

[13] The data driver according to [11], in which
when the voltage to be output corresponding to the value of the gradation signal is the voltage of the voltage division node, the selector section selects at least one reference voltage which shows an undershoot with respect to the voltage to be output, and subsequently selects the voltage of the corresponding voltage division node.

[14] The data driver according to [11], in which
when the voltage to be output corresponding to the value of the gradation signal is the voltage of the voltage division node, the selector section selects at least one reference voltage which shows an overshoot with respect to the voltage to be output and at least one reference voltage which shows an undershoot with respect to the voltage to be output, and subsequently selects the voltage of the corresponding voltage division node.

[15] The data driver according to any one of [11] to [14], further including
a table containing data of a length of a period to select the reference voltage, and a length of a period to select the voltage of the corresponding voltage division node, which data corresponds to the input value of the gradation signal;
the selector section being configured to select the reference voltage or the voltage of the voltage division node in a period controlled based on the data contained in the table.

[16] The data driver according to any one of [11] to [15], in which
when the voltage to be output corresponding to the value of the gradation signal is the voltage of the voltage division node, the selector section selects the reference voltage in a pre-charging period in a horizontal scanning period, and subsequently selects the voltage of the corresponding voltage division node in a data writing period longer than the pre-charging period in the same horizontal scanning period.

[17] A display apparatus including:
a display panel; and
a data driver for driving data lines of the display panel, the data driver including
   a reference voltage section having at least three kinds of reference voltage sources configured to supply their respective reference voltages, the reference voltage sources being arranged in descending or ascending order of voltage values,
   at least one resistance circuit each having a plurality of voltage division nodes connected between adjacent reference voltage sources, the voltage division nodes dividing the reference voltages, and
   a selector section configured to select and allow output of one voltage among the reference voltages or the voltages of the voltage division nodes, the voltage corresponding to an input value of a gradation signal,
      the selector section being configured to, when the voltage to be output corresponding to the value of the gradation signal is one of the voltages of the voltage division nodes, select at least one reference voltage and subsequently select the voltage of the corresponding voltage division node.

It should be understood by those skilled in the art that various modifications, combinations, sub-combinations and alterations may occur depending on design requirements and other factors insofar as they are within the scope of the appended claims or the equivalents thereof.

What is claimed is:

1. A data driver for driving data lines of a display panel, comprising:
a reference voltage section having at least three kinds of reference voltage sources configured to supply their respective reference voltages, the reference voltage sources being arranged in descending or ascending order of voltage values;
at least one resistance circuit each having a plurality of voltage division nodes connected between adjacent reference voltage sources, the voltage division nodes dividing the reference voltages; and
a selector section configured to select and allow output of one voltage among the reference voltages or the voltages of the voltage division nodes, the voltage corresponding to an input value of a gradation signal,
the selector section being configured to, when the voltage to be output corresponding to the value of the gradation signal is one of the voltages of the voltage division nodes, select one of two reference voltages from two reference voltage sources being connected to the resistance circuit including a corresponding voltage division node and subsequently select the voltage of the corresponding voltage division node.

2. The data driver according to claim 1, wherein
when the voltage to be output corresponding to the value of the gradation signal is the voltage of the voltage division node, the selector section selects one reference voltage which shows an overshoot with respect to the voltage to be output, from two reference voltages, and subsequently selects the voltage of the corresponding voltage division node.

3. The data driver according to claim 1, wherein
when the voltage to be output corresponding to the value of the gradation signal is the voltage of the voltage division node, the selector section selects one reference voltage which shows an undershoot with respect to the voltage to be output, from two reference voltages, and subsequently selects the voltage of the corresponding voltage division node.

4. The data driver according to claim 1, further comprising
a table containing data of a length of a period to select the reference voltage, and a length of a period to select the voltage of the corresponding voltage division node, which data corresponds to the input value of the gradation signal;
the selector section being configured to select the reference voltage or the voltage of the voltage division node in a period controlled based on the data contained in the table.

5. The data driver according to claim 1, wherein
when the voltage to be output corresponding to the value of the gradation signal is the voltage of the voltage division node, the selector section selects the reference voltage in a pre-charging period in a horizontal scanning period, and subsequently selects the voltage of the corresponding voltage division node in a data writing period longer than the pre-charging period in the same horizontal scanning period.

6. A display apparatus comprising:
a display panel; and
a data driver for driving data lines of the display panel, the data driver including
a reference voltage section having at least three kinds of reference voltage sources configured to supply their respective reference voltages, the reference voltage sources being arranged in descending or ascending order of voltage values,
at least one resistance circuit each having a plurality of voltage division nodes connected between adjacent reference voltage sources, the voltage division nodes dividing the reference voltages, and
a selector section configured to select and allow output of one voltage among the reference voltages or the voltages of the voltage division nodes, the voltage corresponding to an input value of a gradation signal,
the selector section being configured to, when the voltage to be output corresponding to the value of the gradation signal is one of the voltages of the voltage division nodes, select one of two reference voltages from two reference voltage sources being connected to the resistance circuit including a corresponding voltage division node and subsequently select the voltage of the corresponding voltage division node.

7. A data driver for driving data lines of a display panel, comprising:
a reference voltage section having at least three kinds of reference voltage sources configured to supply their respective reference voltages, the reference voltage sources being arranged in descending or ascending order of voltage values;
at least one resistance circuit each having a plurality of voltage division nodes connected between adjacent reference voltage sources, the voltage division nodes dividing the reference voltages; and
a selector section configured to select and allow output of one voltage among the reference voltages or the voltages of the voltage division nodes, the voltage corresponding to an input value of a gradation signal,
the selector section being configured to, when the voltage to be output corresponding to the value of the gradation signal is one of the voltages of the voltage division nodes, select at least one reference voltage and subsequently select the voltage of the corresponding voltage division node.

8. The data driver according to claim 7, wherein
when the voltage to be output corresponding to the value of the gradation signal is the voltage of the voltage division node, the selector section selects at least one reference voltage which shows an overshoot with respect to the voltage to be output, and subsequently selects the voltage of the corresponding voltage division node.

9. The data driver according to claim 7, wherein
when the voltage to be output corresponding to the value of the gradation signal is the voltage of the voltage division node, the selector section selects at least one reference voltage which shows an undershoot with respect to the voltage to be output, and subsequently selects the voltage of the corresponding voltage division node.

10. The data driver according to claim 7, wherein
when the voltage to be output corresponding to the value of the gradation signal is the voltage of the voltage division node, the selector section selects at least one reference voltage which shows an overshoot with respect to the voltage to be output and at least one reference voltage which shows an undershoot with respect to the voltage to be output, and subsequently selects the voltage of the corresponding voltage division node.

11. The data driver according to claim 7, further comprising
a table containing data of a length of a period to select the reference voltage, and a length of a period to select the voltage of the corresponding voltage division node, which data corresponds to the input value of the gradation signal;
the selector section being configured to select the reference voltage or the voltage of the voltage division node in a period controlled based on the data contained in the table.

12. The data driver according to claim 7, wherein
when the voltage to be output corresponding to the value of the gradation signal is the voltage of the voltage division node, the selector section selects the reference voltage in a pre-charging period in a horizontal scanning period, and subsequently selects the voltage of the corresponding voltage division node in a data writing period longer than the pre-charging period in the same horizontal scanning period.

13. A display apparatus comprising:
a display panel; and
a data driver for driving data lines of the display panel, the data driver including
a reference voltage section having at least three kinds of reference voltage sources configured to supply their respective reference voltages, the reference voltage sources being arranged in descending or ascending order of voltage values,
at least one resistance circuit each having a plurality of voltage division nodes connected between adjacent reference voltage sources, the voltage division nodes dividing the reference voltages, and
a selector section configured to select and allow output of one voltage among the reference voltages or the voltages of the voltage division nodes, the voltage corresponding to an input value of a gradation signal,
the selector section being configured to, when the voltage to be output corresponding to the value of the gradation signal is one of the voltages of the voltage division nodes, select at least one reference voltage and subsequently select the voltage of the corresponding voltage division node.
